(19) United States
(12) Patent Application Publication
(10) Pub. No.: US 2021/0061253 A1
(43) Pub. Date: Mar. 4, 2021

(54) VEHICLE CONTROL APPARATUS

(71) Applicant: HONDA MOTOR CO., LTD., Tokyo (JP)

(72) Inventors: Takashi HASHIZUME, Wako-shi (JP); Ryuichi KIMATA, Tokyo (JP)

(21) Appl. No.: 16/998,193

(22) Filed: Aug. 20, 2020

(30) Foreign Application Priority Data
Sep. 2, 2019 (JP) 2019-159686

(51) Int. Cl. B60W 20/12; B60W 40/076; B60L 58/12; B60W 60/00

(52) U.S. Cl. CPC B60W 20/12; B60W 40/076; B60W 2510/244; B60W 60/001; B60W 2552/15; B60L 58/12

(57) ABSTRACT

A vehicle control apparatus is provided. The apparatus, comprises an inclination sensor; a generator that generates electricity using an engine as a motive power source; a battery that stores electricity that has been generated by the generator; a drive unit that drives a vehicle with a motor that uses the battery as an electric power source; and a control unit that controls charging of the battery, wherein the control unit stops the engine when an inclination detected by the inclination sensor exceeds a reference value.

### CROSS-REFERENCE TO RELATED APPLICATION

This application claims priority to and the benefit of Japanese Patent Application No. 2019-159686 filed on Sep. 2, 2019, the entire disclosure of which is incorporated herein by reference.

### BACKGROUND OF THE INVENTION

### Field of the Invention

The present invention relates to a vehicle control apparatus for controlling, for example, a vehicle that travels autonomously.

### Description of the Related Art

There are hybrid vehicles that use an internal combustion engine and an electric motor as motive power sources. A hybrid vehicle can travel by generating electricity using an internal combustion engine, and by driving an electric motor using this electricity. The electricity for driving the electric motor is first stored into a battery, and then supplied to the electric motor (see, for example, Japanese Patent No. 5962516).

However, it is not possible to operate an engine unlimitedly. For example, with respect to an engine loaded on a vehicle, an allowable value for an inclination on which the engine can be operated is prescribed. If the engine is operated on an inclination that exceeds the allowable value, there is a possibility that, for example, the lubrication oil is not sucked up by a pump due to an inclination of an oil pan, and the supply of the lubrication oil to necessary parts is disabled, thereby causing galling in the engine.

### SUMMARY OF THE INVENTION

The present invention provides a vehicle control apparatus that can control the operation of a hybrid vehicle in accordance with an environment.

The present invention includes the following configuration. Specifically, according to one aspect of the present invention, provided is a vehicle control apparatus, comprising: an inclination sensor; a generator that generates electricity using an engine as a motive power source; a battery that stores electricity that has been generated by the generator; a drive unit that drives a vehicle with a motor that uses the battery as an electric power source; and a control unit that controls charging of the battery, wherein the control unit stops the engine when an inclination detected by the inclination sensor exceeds a reference value.

According to the present invention, the operation of a hybrid vehicle can be controlled in accordance with an environment.

### BRIEF DESCRIPTION OF THE DRAWINGS

FIG. 1A and FIG. 1B are external views of a vehicle according to an embodiment as viewed from the side.

FIG. 2 is a block diagram showing a control configuration of the vehicle according to an embodiment.

FIG. 3A is a diagram showing an example of a procedure of autonomous travelling of the vehicle according to an embodiment.

FIG. 3B is a diagram showing a schematic example of map information according to an embodiment.

FIG. 4 is a flowchart showing exemplary control on an internal combustion engine of a hybrid vehicle according to an embodiment.

FIG. 5 is a flowchart showing exemplary control on an internal combustion engine of a hybrid vehicle according to a second embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

[First Embodiment]

### Configuration of Vehicle

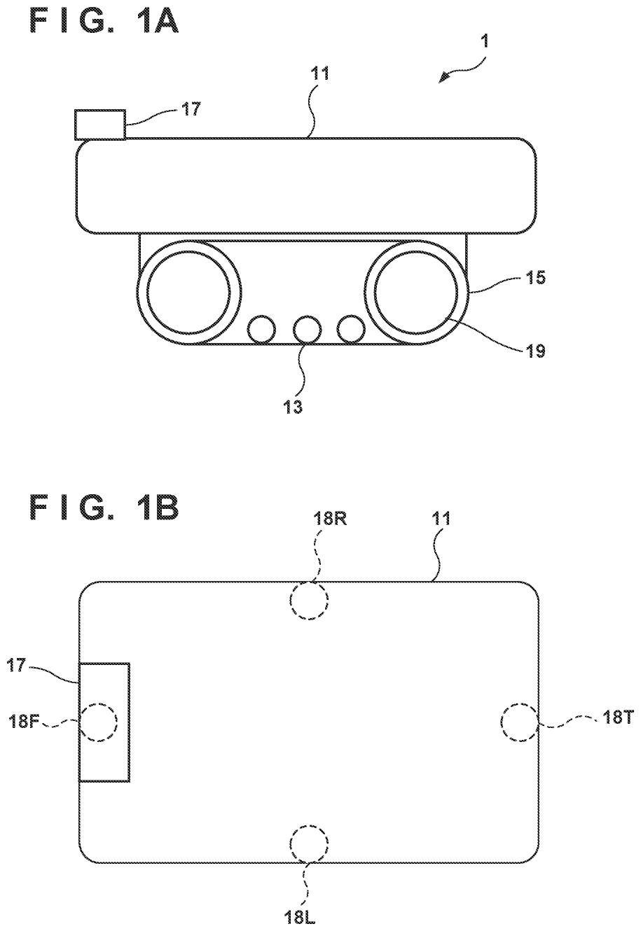

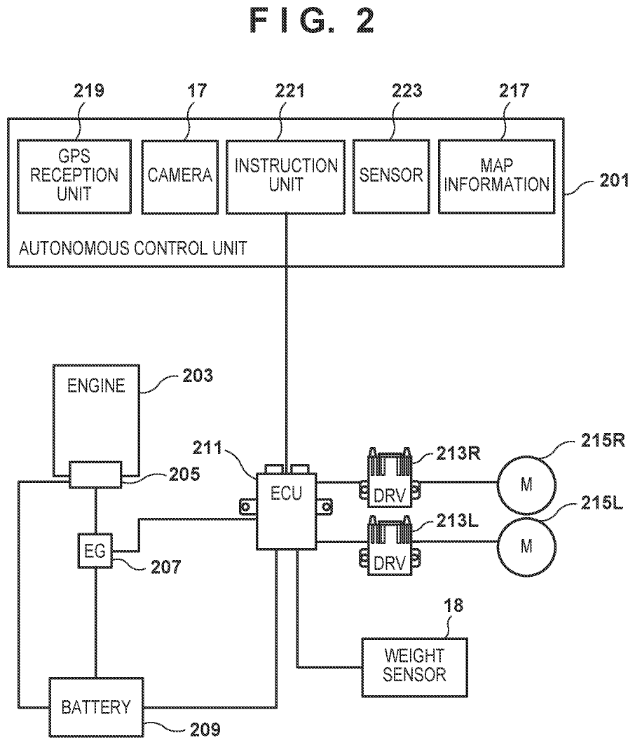

FIG. 1A and FIG. 1B are respectively a side view and a top view of an autonomously-travelling vehicle 1 (hereinafter may be referred to simply as a vehicle 1) according to the present embodiment. The vehicle 1 according to the present embodiment is a tracked vehicle including a main body 11, which has a control unit, a motive power source, and the like built therein, and a crawler 15. The crawler 15 is composed of sprocket wheels 19 that are driven by the motive power source, a crawler belt 13 that is driven by the sprocket wheels 19, and so forth. Furthermore, the main body 11 includes a camera 17 that shoots a certain range centered at the direction of movement, and shot images are used in travel control. That is to say, the camera 17 functions as an external information obtainment unit that obtains information of the outside of the vehicle 1. A control system and a drive system shown in FIG. 2 are housed in the main body 11. The vehicle 1 is a hybrid vehicle that uses a combination of an engine, which is an internal combustion engine, and electric motors as its drive system, generates electricity using the engine, and drives the electric motors using this electricity. In the present example, the vehicle 1 is structured in such a manner that it can travel autonomously in an unmanned state, and freight can be loaded on its upper part. Therefore, members for fixing the loaded freight (load) in place, a fall-prevention cage, and the like may be provided; these, however, are omitted in FIG. 1A and FIG. 19.

Furthermore, a board for the purpose of loading is provided on a top surface, and four weight sensors 18R, 18L, 18F, 18T (may be collectively referred to as weight sensors 18) are provided therebelow. Based on the direction of movement, the weight sensors 18R, 18L are respectively provided on the right and left of a central portion in the front-and-rear direction, whereas the weight sensors 18F, 18T are respectively provided on the front and rear of a central portion in the left-and-right direction. Therefore, the weight sensors 18 can not only detect a total weight of the loaded freight, but also detect weight balance in the front-and-rear direction and the left-and-right direction. Balance in the front-and-rear direction is indicated by the difference between weights that were respectively detected by the weight sensors 18F, 18T, whereas balance in the left-and-right direction is indicated by the difference between weights that were respectively detected by the weight sensors 18L, 18R.

FIG. 2 is a block diagram of the vehicle 1. Autonomous travelling is realized by an autonomous control unit 201 controlling the drive system. First, the drive system will be described. An engine 203 is an internal combustion engine that generates electricity by driving a generator 205. Note that the generator 205 also functions as a starter motor for the engine 203. The engine rotation is controlled by an electronic governor 207 under control of an ECU 211. A battery (secondary battery) 209 is charged with the electricity generated by the generator 205. The electricity stored in the battery 209 is supplied to each of motors 215R, 215L via drivers 213R, 213L. The motors 215R, 215L respectively drive the right and left sprocket wheels 19. The drivers 213R, 213L control electric current supplied to the corresponding motors 215R, 215L. When the motors 215R, 215L are, for example, three-phase induction motors, the drivers 213R, 213L may include an inverter that converts direct current from the battery into alternating current. Accordingly, the rotation speed and torque of each sprocket wheel 19 may be controlled by changing the voltage and frequency of alternating current in accordance with control performed by the ECU 211.

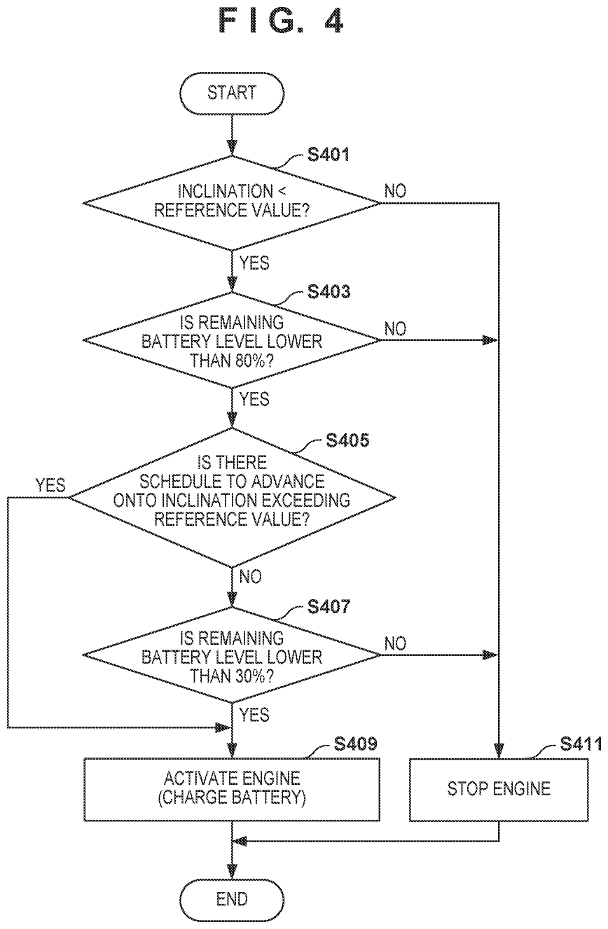

The left and right motors and drivers are independent of one another, and can drive the left and right sprocket wheels 19 independently of each other. It goes without saying that, even when other types of motors are used, the torque and speed thereof can be controlled by adopting drivers that are appropriate therefor. The vehicle 1 turns left or right due to the rotation difference between the left and right motors 215R, 215L; thus, the ECU 211 controls the motors 215R, 215L in accordance with control performed by the autonomous control unit 201, and achieves the speed and steering corresponding to an instruction. The ECU 211 also generates electricity as necessarily by controlling the state of operation (e.g., stopping and starting) of the engine 203. Note that in the present embodiment, it is assumed that charging of the battery is controlled by the ECU 211. Although there is one ECU 211 in FIG. 2, it is permissible to adopt a configuration in which a plurality of independent ECUs are provided in accordance with objects to be controlled, and these are coordinated by one ECU. To this end, the ECU 211 can execute, for instance, a program having a procedure that is exemplarily shown in FIG. 4. Furthermore, the four weight sensors 18 shown in FIG. 1B (collectively shown in FIG. 2) are connected to the ECU 211, and the detected weights are input to the ECU 211.

Next, the autonomous control unit 201 will be described. A GPS reception unit 219 is one example of a position detection device that receives signals from a GPS satellite and inputs them to the ECU 211. Alternatively, the GPS reception unit 219 may specify the current position, and input the specified current position to the ECU 211. A camera 17, which is the same as the camera 17 of FIG. 1A and FIG. 1B, shoots images in the direction of movement (also called the front), and monitors obstacles, signs, and so forth. When the camera 17 is a stereo camera, the distance to a target can be estimated based on parallax. This makes it possible to estimate an inclination, especially an uphill inclination, in the direction of movement. In addition, cameras for monitoring the rear and the sides may be further provided. Sensors 223 may include various types of sensors, and these sensors may include, for example, sensors that are necessary for control, such as an azimuth sensor, an inclination sensor, an acceleration rate sensor, and so forth. It goes without saving that not only the sensors that have been exemplarily described, but also necessary sensors can be included.

Map information 217 is, for example, map information that is stored in a nonvolatile memory, such as a rewritable ROM and a hard disk, and covers a region in which the vehicle 1 is used, and may include information related to paths and facilities along which the vehicle 1 travels, obstacles, sections of the region, and so forth. The sections of the region include an engine operation prohibition area and an engine operation permission area, which will be described later. It is permissible to set only an engine operation prohibition area and regard other areas as engine operation permission areas; conversely, it is permissible to set only an engine operation permission area and regard other areas as engine operation prohibition areas. Furthermore, the map information may include the gradient (inclination) of a path. The gradient may indicate a direction; however, in the present example, it is assumed that only the value of the inclination is included, and the direction of the inclination may not be included. Note that engine operation refers to the act of putting the engine 203, which is the internal combustion engine, in motion, and an engine operation prohibition area refers to an area in which the engine 203 must not be operated. Once a destination has been set via, for example, an operation unit and a communication unit, which are not shown, the autonomous control unit 201 determines a path from the current location to the destination based on the map information 217, and controls a drive unit so as to travel along this path.

An instruction unit 221 determines a speed and a steering angle based on, for example, the current position obtained from the GPS reception device 219, the status of the surroundings of the vehicle 1 that has been obtained using the camera 17, various types of sensors 223, and the like, a travel path that has been determined, and the map information 217, and inputs an instruction signal to the ECU 211 of the drive system. Upon accepting the instruction signal, the ECU 211 controls the motors 215R, 215L to achieve the speed and the steering angle of the instruction.

### Outline of Autonomous Travelling

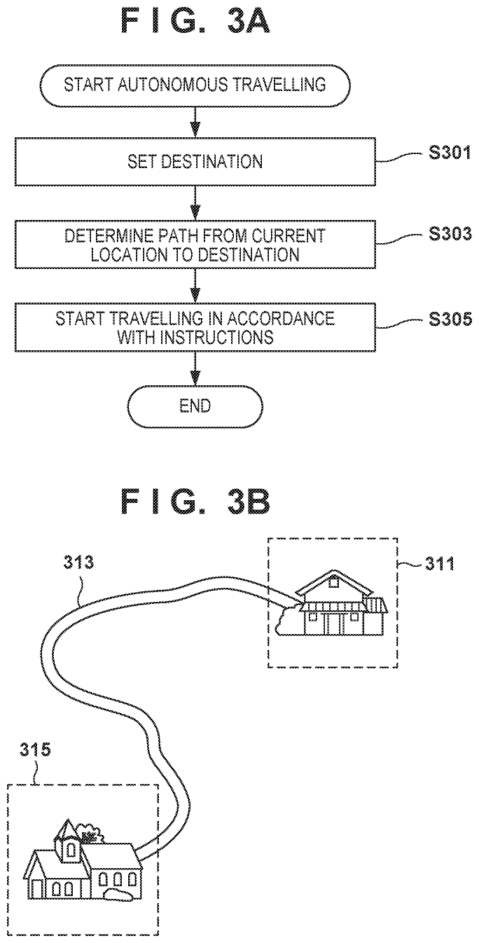

FIG. 3A shows an outline of a procedure at the time of autonomous travelling of the vehicle 1. This procedure is executed by the autonomous control unit 201, especially the instruction unit 221. First, the setting of a destination that has been made by an operator via the operation unit 201 is accepted (step S301). The setting of the destination may be made by, for example, displaying a map of the vicinity of the current location, and causing the destination to be designated on the map or to be designated using coordinates, houses that are displayed, and the like. The instruction unit 221 determines the current location from GPS signals received by the GPS reception unit 219, and determines a path from the current location to the destination (step S303). As the path, for example, a path along a road (or an aisle) may be determined. Also, a path corresponding to the designated destination may be determined from among paths that have been defined in advance for respective destinations. Then, in response to an instruction to start travelling, an instruction signal is input to the ECU 211 so as to drive the motors 215R, 2151, and travelling along the determined path is started (step S305). During travel, the GPS reception unit 219 obtains position information of the current location (the current position), and the direction of movement is controlled so as to travel along the determined path. Furthermore, the camera 17 monitors the surroundings centered at the direction of movement; if an obstacle is discovered, control is performed so as to avoid the obstacle, stop, or decelerate.

FIG. 3B shows an example of a path that has been determined based on the map information 217. A destination 311 is the destination that was set in step S301. A current location 315 is the current location that was obtained in step S303, and a path 313 is the path that connects the current location 315 and the destination 311 in the map information 217. In determining the path, it is sufficient to select, for example, the shortest path among the roads (or aisles) that connect the current location and the destination, or a path that has been determined in advance in correspondence with the destination. Here, as the path 313 is not necessarily a public road and the vehicle 1 is a vehicle that has the crawler instead of wheels, an inclination that exceeds a limit value that allows the engine to be operated could possibly exist midway through the path 313.

in view of this, the vehicle 1 monitors an inclination of the vehicle 1 using the inclination sensor included in the sensors 223, and stops the engine 203 when the inclination exceeds the limit value that allows the engine to be operated, or when the inclination reaches a predetermined reference value that is smaller than this limit value (it is assumed that the limit value and the reference value are collectively referred to as the reference value). As long as the inclination of the vehicle 1 exceeds the reference value, the engine is not operated. Furthermore, because the battery 209 cannot be charged as long as the inclination of the vehicle 1 exceeds the reference value, the battery is charged in advance when it can be predicted that the inclination of the vehicle 1 will exceed the reference value. Note that the limit value for the inclination has been set in accordance with, for example, the specifications of the engine to be used. Also, a limitation on the inclination may differ between, for example, the direction of a crankshaft and the direction perpendicular thereto; however, in the present embodiment, it is assumed that the same limit value has been set with respect to every azimuth for the sake of simplicity. Therefore, the inclination described below refers to a degree of the inclination, whether the inclination extends in the front-and-rear direction or the left-and-right direction. If the direction of the inclination poses an issue, it is sufficient to, for example, set different reference values for the front-and-rear direction and the left-and-right direction, detect the inclinations in respective directions, and compare them with the reference value.

### Control on Driving of Engine

FIG. 4 shows a procedure for controlling the engine 203 according to the present embodiment, which is executed by the ECU 211. This procedure is executed periodically, for example, every 10 milliseconds, while the vehicle 1 is travelling. First, whether the current inclination obtained by the inclination sensor is smaller than a reference value is determined (step S401). The method of determination is as described in the foregoing example.

When it is determined that the current inclination is equal to or larger than the reference value, the engine 203 is stopped (step S411). When in the stopped state already, this state is maintained. On the other hand, when it is determined that the current inclination is smaller than the reference value, whether the remaining level of the battery is lower than a first threshold (in the present example, 80 percent) is determined (step S403). When the remaining level is equal to or higher than 80 percent, processing branches off to step S411, and the engine is stopped.

When it is determined that the remaining battery level is lower than 80 percent, whether advancement onto an inclination that exceeds the reference value is scheduled is determined (step S405). A case where advancement onto an inclination that exceeds the reference value is scheduled may include, for example, a case where an uphill, a downhill, or a traverse with an inclination that exceeds the reference value exists midway through the determined path that is supposed to be taken from now. Alternatively, it may be a case where, with the addition of time and distance requirements, it is predicted that an inclination that exceeds the reference value will be reached within a predetermined period based on the current speed and the distance to the inclination that exceeds the reference value. Alternatively, it may be a case where an inclination that exceeds the reference value exists at a distance closer than a predetermined distance in the direction of movement. That is to say, it is permissible to determine that advancement onto an inclination exceeding the reference value is scheduled when the determined path is predicted to pass over an inclination exceeding the reference value that is specified in the map information 217, and furthermore, it is permissible to use an additional condition that a predicted period until the passing is equal to or shorter than a predetermined period or the distance is within the predetermined distance. Alternatively, when the camera 17 is, for example, a stereo camera, several points on a road on which the vehicle is supposed to travel from now are specified, and the distances to and the heights of these points are obtained. Then, the inclinations between the points may be estimated, and whether these inclinations exceed the reference value may be determined. Note that this method applies to an uphill inclination. In the case of a downhill, the larger the inclination becomes along with the movement, the more difficult it becomes to observe an anterior path. Therefore, it is permissible to determine that advancement onto an inclination that exceeds the reference value is scheduled also when an anterior path is not visible in images shot by the camera. In any case, the determination in step S405 is based on an instruction from the autonomous control unit 201. That is to say, when the autonomous control unit 201 determines that advancement onto an inclination that exceeds the reference value is scheduled, a signal to that effect is input to the ECU 211. In step S405, the ECU 211 makes the determination based on this signal.

When it is determined that advancement onto an inclination that exceeds the reference value is scheduled, the engine is started, and the battery is charged (step S409). When the engine is already in the operated state, it is sufficient to maintain this state. On the other hand, when it is determined that such advancement is not scheduled, whether the remaining level of the battery is lower than a second threshold (in the present example, 30 percent) is determined (step S407). When the remaining level of the battery is equal to or higher than 30 percent, the engine is stopped in step S411; when the remaining level is lower than 30 percent, the engine is started in step S409.

With the foregoing configuration and control, the vehicle 1 of the present embodiment stops the engine and travels using the electric motors on an inclination that exceeds the reference value. Furthermore, even outside an inclination that exceeds the reference value, the engine is stopped when the remaining battery level is equal to or higher than the first threshold. Furthermore, as a general rule, the engine is stopped when the remaining battery level is equal to or higher than the second threshold; however, when advancement onto an inclination that exceeds the reference value is scheduled, the engine is started regardless of the remaining battery level. As a result, the remaining battery level necessary for travel can be secured on an inclination that exceeds the reference value. In this way, the operation of a hybrid vehicle can be controlled in accordance with a travel environment.

[Second Embodiment]

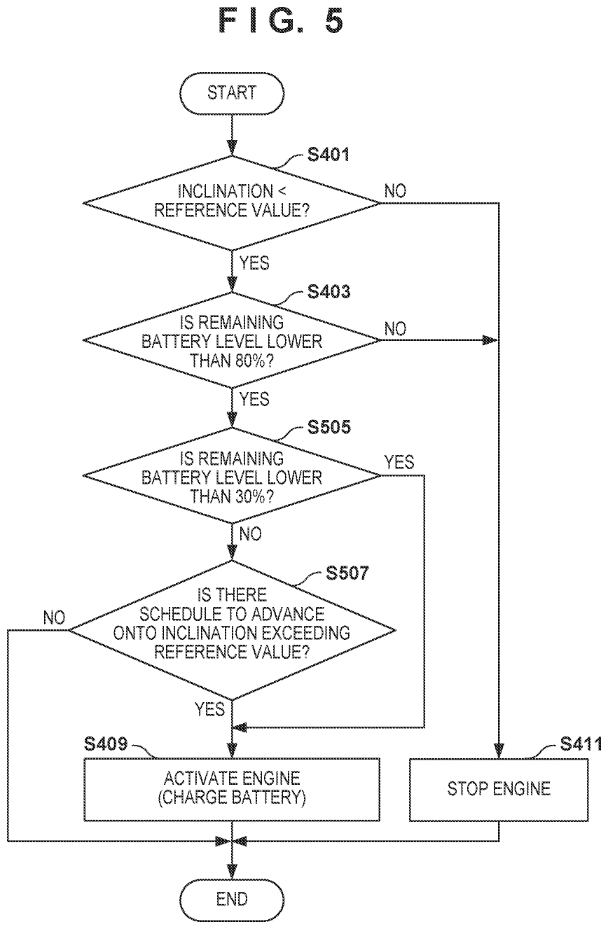

A vehicle according to the second embodiment is the same as that of the first embodiment in relation to FIG. 1A to FIG. 3B. However, the procedure for controlling driving of the engine shown in FIG. 4 is replaced with a procedure shown in FIG. 5.

In FIG. 5, steps S401 and S403 are similar to those of FIG. 4. Steps S505 and S507 are respectively equivalent to steps S407 and S405 of FIG. 4, but their order and branch destinations differ. When it is determined that the remaining battery level is lower than the first threshold in step S403, processing branches off to step S505. In step S505, whether the remaining battery level is lower than the second threshold is determined. When the remaining battery level is lower than the second threshold, the engine is started (step S409). On the other hand, when the remaining battery level is equal to or higher than the second threshold, whether advancement onto an inclination that exceeds the reference value is scheduled is determined (step S507). When advancement onto an inclination that exceeds the reference value is scheduled, the engine is started (step S409). On the other hand, when advancement onto an inclination that exceeds the reference value is not scheduled, processing is ended, and the state of the engine is maintained as is. That is to say, when the engine is driven, the driven state is maintained, whereas when the engine is stopped, the stopped state is maintained.

With this control, the engine is stopped on an inclination that exceeds the reference value. On the other hand, outside an inclination that exceeds the reference value, the engine is stopped when the remaining battery level is equal to or higher than the first threshold, and the engine is driven when the remaining battery level is lower than the second threshold. In a case where the remaining battery level is lower than the first threshold and is equal to or higher than the second threshold, the engine is driven when advancement onto an inclination that exceeds the reference value is scheduled, but the state of the engine is maintained without being changed when such advancement is not scheduled. That is to say, in a case where advancement onto an inclination that exceeds the reference value is not scheduled, charging is started when the remaining level of the battery becomes lower than the second threshold, and charging is stopped when the remaining level becomes equal to or higher than the first threshold. By performing control in the foregoing manner, the engine and the battery can be used more efficiently. Especially, the frequency of charging of the battery can be reduced. Furthermore, as the minimum remaining battery level is approximately the second threshold (in the present example, 30 percent), the remaining battery level that is sufficient for driving with the motors can be secured even if the engine is stopped on an inclination that exceeds the reference value. In this way, the operation of a hybrid vehicle can be controlled in accordance with a travel environment.

Note that if the second threshold is sufficient as the reference value of the remaining battery level, step S507 may be omitted. In this case, when it is determined that the remaining level is equal to or higher than the second threshold in step S505, it is sufficient to end processing at that point.

[Modification Examples]

A description is now given of several modification examples that are common to the first and second embodiments.

(1) The vehicle 1 may be a wheeled vehicle that uses normal wheels as driving wheels and steered wheels, in which case there may be one electric motor for the purpose of driving. Instead, the vehicle 1 includes a steering mechanism for steering the steered wheels left and right. Furthermore, in place of freight or in addition to freight, a passenger may be able to board the vehicle 1.

(2) While it is assumed that the vehicle 1 can travel autonomously based on information of the map and the surroundings, a path that can be travelled may be determined in advance. For example, magnetic markers may be installed along a travel path, and the vehicle 1 may be a vehicle that travels along the path by detecting these markers. In this case, an inclination that exceeds a reference value can be specified as a two-dimensional section along this path. This can simplify a configuration necessary for autonomous driving,

(3) Although an inclination that exceeds a reference value is specified based on the position information, it may be specified based on signs. For example, when a path on which the vehicle 1 can travel includes an inclination exceeding the reference value, a sign that gives early warning of the inclination exceeding the reference value is set ahead of this inclination. The sign that gives early warning of the inclination exceeding the reference value is detected from images that have been shot by the vehicle 1 using the camera 17. When this sign has been detected, electricity is generated by operating the engine under the assumption that the vehicle will advance onto the inclination exceeding the reference value. In this way, the battery can be charged in advance when advancement onto the inclination exceeding the reference value is scheduled. Note that signs may not be visual objects that are recognized by the camera 17; for example, magnetic markers may be embedded, and they may be regarded as signs when magnetically detected. This makes it easier to predict advancement onto the inclination exceeding the reference value.

(4) When the engine has been started as a result of determining that advancement onto an inclination that exceeds the reference value is scheduled in step S405 of FIG. 4 or step S507 of FIG. 5, control may be performed so as not to advance onto the inclination that exceeds the reference value until the remaining battery level becomes equal to or higher than a predetermined value. For example, when the engine has been started, the vehicle 1 is stopped on the spot (or after evacuating to a safe place); the vehicle 1 stays there until the remaining battery level reaches the predetermined value, and resumes travelling when the remaining battery level has reached the predetermined value. This predetermined value may be a third threshold between the first threshold and the second threshold. This can reliably prevent the engine from being stopped after advancing onto an inclination that exceeds the reference value in an insufficiently charged state.

(5) A hybrid system of the embodiments is a so-called series hybrid type in which the battery is charged by the engine for the purpose of charging and the electric motors are driven by the battery. In contrast, the invention pertaining to the present embodiments is also applicable to a hybrid system in which the engine can be used also for the purpose of travelling. The difference from the embodiments is that, while travelling in a state where the engine has been started, the engine may be used not only for the purpose of charging but also for the purpose of travelling, as opposed to the embodiments in which the engine is used exclusively for the purpose of charging.

### Summary of Embodiments

The above-described present embodiments are summarized as follows.

(1) According to a first mode of the present invention, provided is a vehicle control apparatus including: an inclination sensor; a generator that generates electricity using an engine as a motive power source; a battery that stores electricity that has been generated by the generator; a drive unit that drives a vehicle with a motor that uses the battery as an electric power source; and a control unit that controls charging of the battery, wherein the control stops the engine when an inclination detected by the inclination sensor exceeds a reference value.

In this way, the engine is stopped on an inclination that exceeds the reference value; accordingly, the engine can be protected, and the operation of a hybrid vehicle can be controlled in accordance with an environment.

(2) According to a second mode of the present invention, provided is the vehicle control apparatus according to (1), wherein the control unit further starts the engine when the vehicle is scheduled to advance onto an inclination that exceeds the reference value.

In this way, the remaining battery level can be secured more reliably on an inclination that exceeds the reference value.

(3) According to a third mode of the present invention, provided is the vehicle control apparatus according to (2), further including an obtainment unit that obtains information of an outside, wherein when it is predicted, with use of the obtainment unit, that an inclination in a direction of movement of the vehicle exceeds the reference value, the control unit determines that the vehicle is scheduled to advance onto an inclination that exceeds the reference value.

In this way, an inclination that exceeds the reference value can be predicted reliably based on information obtained during travel.

(4) According to a fourth mode of the present invention, provided is the vehicle control apparatus according to (2), further including a storage unit that stores map information, wherein the control unit determines that the vehicle is scheduled to advance onto an inclination that exceeds the reference value based on the map information.

In this way, as an inclination that exceeds the reference value is defined in the map information, the engine can be stopped based on specification of the inclination that exceeds the reference value during autonomous driving, and the inclination that exceeds the reference value can be set by performing an operation with respect to the map information.

(5) According to a fifth mode of the present invention, provided is the vehicle control apparatus according to any one of (1) to (4), wherein the control unit stops the engine when a remaining level of the battery is equal to or higher than a first reference value, and starts the engine when the remaining level of the battery is lower than a second reference value.

In this way, the remaining battery level can be secured on an inclination that exceeds the reference value by charging the battery when the remaining battery level has become lower than a predetermined level, and furthermore, unnecessary engine operation can be prevented by stopping the engine when the remaining battery level has become equal to or higher than the predetermined level.

(6) According to a sixth mode of the present invention, provided is the vehicle control apparatus according to (5), wherein the control unit does not change a state of operation of the engine when the remaining level of the battery is lower than the first reference value and is equal to or higher than the second reference value.

In this way, the frequency of charging of the battery can be reduced, and draining of the battery can be prevented.

(7) According to a seventh mode of the present invention, provided is the vehicle control apparatus according to any one of (1) to (6), further including: a position detection unit that obtains position information of a current location of the vehicle; and a storage unit that stores map information, wherein the control unit further controls autonomous travelling of the vehicle based on the position information of the current location and the map information.

In this way, with respect to a vehicle that travels autonomously, the operation of a hybrid vehicle can be controlled in accordance with an environment.

(8) According to an eighth mode of the present invention, provided is the vehicle control apparatus according to any one of (1) to (7), wherein when the vehicle is scheduled to advance onto an inclination that exceeds the reference value, the control unit charges the battery without driving the motor.

In this way, a sufficient remaining battery level can be secured before advancing onto an inclination that exceeds the reference value.

The invention is not limited to the foregoing embodiments, and various variations/changes are possible within the spirit of the invention.

What is clamed is:

1. A vehicle control apparatus, comprising:
an inclination sensor;
a generator that generates electricity using an engine as a motive power source;
a battery that stores electricity that has been generated by the generator;
a drive unit that drives a vehicle with a motor that uses the battery as an electric power source; and
a control unit that controls charging of the battery,
wherein the control unit stops the engine when an inclination detected by the inclination sensor exceeds a reference value.

2. The vehicle control apparatus according to claim 1, wherein
the control unit further starts the engine when the vehicle is scheduled to advance onto an inclination that exceeds the reference value.

3. The vehicle control apparatus according to claim 2, further comprising
an obtainment unit that obtains information of an outside,
wherein when it is predicted, with use of the obtainment unit, that an inclination in a direction of movement of the vehicle exceeds the reference value, the control unit determines that the vehicle is scheduled to advance onto an inclination that exceeds the reference value.

4. The vehicle control apparatus according to claim 2, further comprising
a storage unit that stores map information,
wherein the control unit determines that the vehicle is scheduled to advance onto an inclination that exceeds the reference value based on the map information.

5. The vehicle control apparatus according to claim 1, wherein
the control unit stops the engine when a remaining level of the battery is equal to or higher than a first reference value, and starts the engine when the remaining level of the battery is lower than a second reference value.

6. The vehicle control apparatus according to claim 5, wherein
the control unit does not change a state of operation of the engine when the remaining level of the battery is lower than the first reference value and is equal to or higher than the second reference value.

7. The vehicle control apparatus according to claim 1, further comprising:
a position detection unit that obtains position information of a current location of the vehicle; and
a storage unit that stores map information,
wherein the control unit further controls autonomous travelling of the vehicle based on the position information of the current location and the map information.

8. The vehicle control apparatus according to claim 1, wherein
when the vehicle is scheduled to advance onto an inclination that exceeds the reference value, the control unit charges the battery without driving the motor.
